(19) United States
(12) Patent Application Publication
(10) Pub. No.: US 2025/0021904 A1
(43) Pub. Date: Jan. 16, 2025

(54) ALLOCATION RESULT DETERMINATION DEVICE AND ALLOCATION RESULT DETERMINATION METHOD

(71) Applicant: Mitsubishi Electric Corporation, Tokyo (JP)

(72) Inventors: Tadashi ONISHI, Tokyo (JP); Nobuyuki YOSHIKAWA, Tokyo (JP)

(73) Assignee: Mitsubishi Electric Corporation, Tokyo (JP)

(21) Appl. No.: 18/901,138

(22) Filed: Sep. 30, 2024

Related U.S. Application Data
(63) Continuation of application No. PCT/JP2022/020003, filed on May 12, 2022.

(51) Int. Cl. G06Q 10/0631; G06Q 40/06; G06Q 50/40

(52) U.S. Cl. CPC G06Q 10/06316; G06Q 40/06; G06Q 50/40

(57) ABSTRACT

This allocation result determination device includes a change cost calculating unit that acquires a first allocation result determined at a first time and a second allocation result determined at a second time later than the first time as an allocation result indicating the allocation order for a plurality of objects to be allocated, and calculates a change cost that is an amount of increase in cost when the allocation result is changed from the first allocation result to the second allocation result. The allocation result determination device also includes an allocation result selecting unit that selects the first allocation result or the second allocation result on the basis of the change cost calculated by the change cost calculating unit.

### CROSS REFERENCE TO RELATED APPLICATION

This application is a Continuation of PCT International Application No. PCT/JP2022/020003, filed on May 12, 2022, which is hereby expressly incorporated by reference into the present application.

### TECHNICAL FIELD

The present disclosure relates to an allocation result determination device and an allocation result determination method.

### BACKGROUND ART

There is, for example, a landing sequence determining device that determines a landing sequence of a plurality of aircrafts (see, for example, Patent Literature 1) as a device that determines an allocation order for a plurality of objects to be allocated. The landing sequence determining device includes a scheduler that determines the landing sequence of the plurality of aircrafts on the basis of an estimated time of arrival at which each aircraft arrives at a runway and the size of each aircraft. The scheduler redetermines the landing sequence of the plurality of aircrafts in a case where, for example, the estimated time of arrival of any of the aircraft is changed after determining the landing sequence of the plurality of aircrafts.

### CITATION LIST

### Patent Literatures

Patent Literature 1: JP 2006-523874 A

### SUMMARY OF INVENTION

### Technical Problem

In a case where the estimated time of arrival of any of the aircraft is changed after the landing sequence of the plurality of aircrafts is determined, the operational cost may be lower when the landing sequence is changed than when the determined landing sequence is maintained, and the operational cost may be lower when the landing sequence is maintained than when the landing sequence is changed. Examples of the operational cost include, in addition to the fuel cost of the aircraft, a burden cost related to a physical burden of a pilot or a mental burden of the pilot.

The landing sequence determining device disclosed in Patent Literature 1 has a problem that the operational cost may be increased by the scheduler changing the landing sequence of the plurality of aircrafts when the estimated time of arrival of any of the aircraft is changed after the scheduler determines the landing sequence of the plurality of aircrafts.

The present disclosure has been made to address the above problem, and an object of the present disclosure is to obtain an allocation result determination device and an allocation result determination method with which it is possible to select a first allocation result or a second allocation result on the basis of cost when the second allocation result is determined after the first allocation result is determined as an allocation result indicating the allocation order for a plurality of objects to be allocated.

### Solution to Problem

The allocation result determination device according to the present disclosure includes a processor; and a memory storing a program, upon executed by the processor, to perform a process: to acquire a first allocation result determined at a first time and a second allocation result determined at a second time later than the first time as an allocation result indicating an allocation order for a plurality of objects to be allocated, and calculate a change cost that is an amount of increase in cost when the allocation result is changed from the first allocation result to the second allocation result; to give each of the first allocation result and the second allocation result to a learning model for reward value prediction, acquire a first reward value indicating a degree of quality of the first allocation result and a second reward value indicating a degree of quality of the second allocation result from the learning model, and predict a reward value difference between the first reward value and the second reward value by subtracting the first reward value from the second reward value; to select the first allocation result or the second allocation result on a basis of a change cost calculated; and to calculate the first reward value by giving the first allocation result to a reward function, calculate the second reward value by giving the second allocation result to the reward function, and calculate a reward value difference between the first reward value and the second reward value by subtracting the first reward value from the second reward value. The process updates the learning model so as to decrease a difference between the reward value difference that has been predicted and the reward value difference calculated, and the process selects the second allocation result when the reward value difference is larger than 0 and the change cost is smaller than or equal to a cost threshold, and selects the first allocation result otherwise.

### Advantageous Effects of Invention

According to the present disclosure, it is possible to select the first allocation result or the second allocation result on the basis of cost when the second allocation result is determined after the first allocation result is determined as the allocation result indicating the allocation order for the plurality of objects to be allocated.

### BRIEF DESCRIPTION OF DRAWINGS

FIG. 1 is a configuration diagram illustrating an allocation result determination device according to a first embodiment.

FIG. 2 is a hardware configuration diagram illustrating hardware of the allocation result determination device according to the first embodiment.

FIG. 3 is a hardware configuration diagram of a computer in a case where the allocation result determination device is implemented by software, firmware, or the like.

FIG. 4 is a configuration diagram illustrating a difference prediction processing unit 6 of the allocation result determination device according to the first embodiment.

FIG. 5 is an explanatory diagram illustrating an example of an allocation result indicating an allocation order of landing of three airplanes.

FIG. 6 is a flowchart illustrating an allocation result determination method which is a processing procedure performed by the allocation result determination device illustrated in FIG. 1.

FIG. 7A is an explanatory diagram illustrating an example of a first allocation result Xₐ acquired by a first allocation result acquiring unit 1 when schedule information Sₐ is given to the first allocation result acquiring unit 1, and FIG. 7B is an explanatory diagram illustrating an example of a second allocation result X_{b} acquired by a second allocation result acquiring unit 2 when schedule information S_{b} is given to the second allocation result acquiring unit 2.

FIG. 8 is an explanatory diagram illustrating an example of a change cost table.

FIG. 9 is an explanatory diagram illustrating an attenuation function g(j).

FIG. 10A is an explanatory diagram illustrating difference information d_{ab} in a case where the allocation order of an aircraft j₄ is changed from the fourth position counted from the top to the last, and FIG. 10B is an explanatory diagram illustrating difference information d_{ab} in a case where an aircraft j₈ that is not included in the schedule information Sₐ is included in the schedule information S_{b}.

FIG. 11 is a configuration diagram illustrating an allocation result determination device according to a second embodiment.

FIG. 12 is a hardware configuration diagram illustrating hardware of the allocation result determination device according to the second embodiment.

FIG. 13 is a configuration diagram illustrating a reward value difference calculating unit 8 of the allocation result determination device according to the second embodiment.

FIG. 14 is a configuration diagram illustrating a difference prediction processing unit 10 of the allocation result determination device according to the second embodiment.

FIG. 15 is a configuration diagram illustrating an allocation result determination device according to a third embodiment.

FIG. 16 is a hardware configuration diagram illustrating hardware of the allocation result determination device according to the third embodiment.

FIG. 17A is an explanatory diagram illustrating times at which allocation is possible and times at which allocation is impossible, and FIG. 17B is an explanatory diagram illustrating a penalty table.

### DESCRIPTION OF EMBODIMENTS

In order to describe the present disclosure in more detail, embodiments for carrying out the present disclosure will now be described with reference to the accompanying drawings.

### First Embodiment

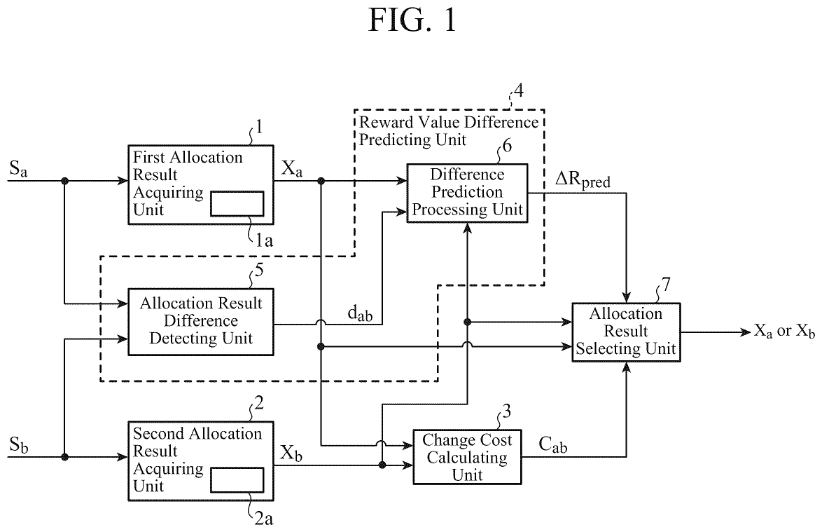

FIG. 1 is a configuration diagram illustrating an allocation result determination device according to a first embodiment.

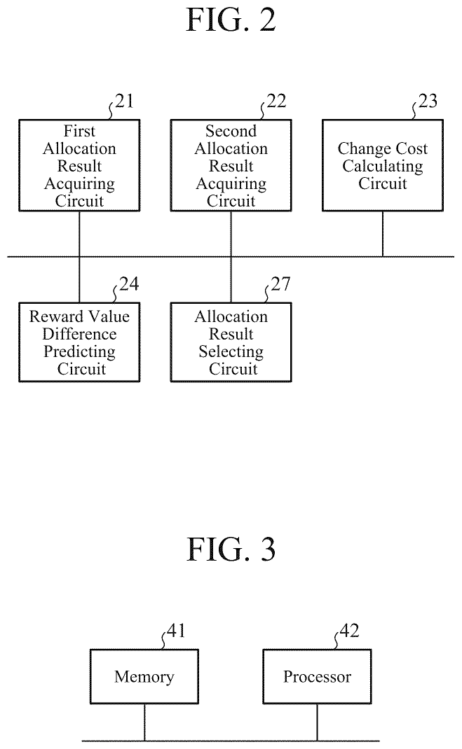

FIG. 2 is a hardware configuration diagram illustrating hardware of the allocation result determination device according to the first embodiment.

The allocation result determination device illustrated in FIG. 1 includes a first allocation result acquiring unit 1, a second allocation result acquiring unit 2, a change cost calculating unit 3, a reward value difference predicting unit 4, and an allocation result selecting unit 7.

It is assumed that the allocation result determination device illustrated in FIG. 1 determines, for example, an allocation result indicating an allocation order of take-off and landing of a plurality of aircrafts as an allocation result indicating an allocation order of a plurality of objects to be allocated. Note that the objects to be allocated are not limited to aircraft, and may be, for example, luggage or taxis. In a case where the objects to be allocated are, for example, taxis, the allocation result determination device illustrated in FIG. 1 determines an allocation result indicating an allocation order of taxis.

The first allocation result acquiring unit 1 is implemented by, for example, a first allocation result acquiring circuit 21 illustrated in FIG. 2.

The first allocation result acquiring unit 1 gives schedule information Sₐ of the aircraft that is the plurality of objects to be allocated at a first time to a first learning model 1a, and acquires first allocation result Xₐ from the first learning model 1a.

The first allocation result acquiring unit 1 outputs the first allocation result Xₐ to each of the change cost calculating unit 3, the reward value difference predicting unit 4, and the allocation result selecting unit 7.

The schedule information Sₐ includes, for example, information indicating an estimated time of landing of each aircraft or an estimated time of take-off of each aircraft, and the size of each aircraft. The first allocation result Xₐ is an allocation result determined at the first time.

At the time of learning, the first learning model 1a is given schedule information S of the plurality of aircrafts as input data, is given an allocation result X indicating the allocation order of take-off and landing of the plurality of aircrafts as training data, and learns the allocation result X.

When being given the schedule information Sₐ of the plurality of aircrafts, the first learning model 1a outputs the first allocation result Xₐ corresponding to the schedule information Sₐ at the time of inference.

Here, the first learning model 1a learns by supervised learning. However, this is merely an example, and the first learning model 1a may learn by, for example, unsupervised learning, reinforcement learning, or a mathematical optimization method.

The second allocation result acquiring unit 2 is implemented by, for example, a second allocation result acquiring circuit 22 illustrated in FIG. 2.

The second allocation result acquiring unit 2 gives schedule information S_{b} of the aircraft that is the plurality of objects to be allocated at a second time later than the first time to a second learning model 2a, and acquires second allocation result X_{b} from the second learning model 2a.

The schedule information S_{b} includes, for example, information indicating an estimated time of landing of each aircraft or an estimated time of take-off of each aircraft, and the size of each aircraft. The second allocation result X_{b} is an allocation result determined at the second time.

The second allocation result acquiring unit 2 outputs the second allocation result X_{b} to each of the change cost calculating unit 3, the reward value difference predicting unit 4, and the allocation result selecting unit 7.

At the time of learning, the second learning model 2a is given the schedule information S of the plurality of aircrafts as input data, is given the allocation result X indicating the allocation order of take-off and landing of the plurality of aircrafts as training data, and learns the allocation result X.

When being given the schedule information S_{b} of the plurality of aircrafts, the second learning model 2a outputs the second allocation result X_{b} corresponding to the schedule information S_{b} at the time of inference.

Here, the second learning model 2a learns by supervised learning. However, this is merely an example, and the second learning model 2a may learn by, for example, unsupervised learning, reinforcement learning, or a mathematical optimization method.

The change cost calculating unit 3 is implemented by, for example, a change cost calculating circuit 23 illustrated in FIG. 2.

The change cost calculating unit 3 acquires the first allocation result Xₐ from the first allocation result acquiring unit 1, and acquires the second allocation result X_{b} from the second allocation result acquiring unit 2.

The change cost calculating unit 3 calculates a change cost C_{ab} which is an amount of increase in cost when the allocation result is changed from the first allocation result Xₐ to the second allocation result X_{b}. When the objects to be allocated are aircraft, the cost for which an amount of increase is calculated by the change cost calculating unit 3 is operational cost. Examples of the operational cost include, in addition to the fuel cost of the aircraft, a burden cost related to a physical burden of a pilot or a mental burden of the pilot.

The change cost calculating unit 3 outputs the change cost C_{ab} to the allocation result selecting unit 7.

The reward value difference predicting unit 4 is implemented by, for example, a reward value difference predicting circuit 24 illustrated in FIG. 2.

The reward value difference predicting unit 4 includes an allocation result difference detecting unit 5 and a difference prediction processing unit 6.

The reward value difference predicting unit 4 gives each of the first allocation result Xₐ and the second allocation result X_{b} to a learning model 6c for reward value prediction illustrated in FIG. 4, and acquires, from the learning model 6c, a first reward value R_{preda} indicating a degree of quality of the first allocation result Xₐ and a second reward value R_{predb} indicating a degree of quality of the second allocation result X_{b}.

The reward value difference predicting unit 4 subtracts the first reward value R_{preda} from the second reward value R_{predb} to predict a reward value difference ΔR_{pred} between the first reward value R_{preda} and the second reward value R_{predb}.

The reward value difference predicting unit 4 outputs the reward value difference ΔR_{pred} to the allocation result selecting unit 7.

The allocation result difference detecting unit 5 detects a difference between the schedule information Sₐ at the first time and the schedule information S_{b} at the second time, and outputs difference information d_{ab} indicating the difference to the difference prediction processing unit 6.

When the difference information d_{ab} output from the difference prediction processing unit 6 indicates that there is a difference, the difference prediction processing unit 6 gives each of the first allocation result Xₐ and the second allocation result X_{b} to the learning model 6c for reward value prediction, and acquires the first reward value R_{preda} and the second reward value R_{predb} from the learning model 6c.

The difference prediction processing unit 6 subtracts the first reward value R_{preda} from the second reward value R_{predb} to predict a reward value difference ΔR_{pred} between the first reward value R_{preda} and the second reward value R_{predb}.

The difference prediction processing unit 6 outputs the reward value difference ΔR_{pred} to the allocation result selecting unit 7.

The allocation result selecting unit 7 is implemented by, for example, an allocation result selecting circuit 27 illustrated in FIG. 2.

The allocation result selecting unit 7 selects the first allocation result Xₐ or the second allocation result X_{b} on the basis of the change cost C_{ab} calculated by the change cost calculating unit 3.

Specifically, the allocation result selecting unit 7 selects the second allocation result X_{b} when the reward value difference ΔR_{pred} predicted by the reward value difference predicting unit 4 is larger than 0 and the change cost C_{ab} is equal to or less than a cost threshold Thc.

The allocation result selecting unit 7 selects the first allocation result Xₐ when the reward value difference ΔR_{pred} is equal to or less than 0 or the change cost C_{ab} is larger than the cost threshold Thc.

The cost threshold Thc may be stored in an internal memory of the allocation result selecting unit 7 or may be given from the outside of the allocation result determination device.

FIG. 1 illustrates an example in which the first allocation result acquiring unit 1, the second allocation result acquiring unit 2, the change cost calculating unit 3, the reward value difference predicting unit 4, and the allocation result selecting unit 7, which are components of the allocation result determination device, are each implemented by dedicated hardware as illustrated in FIG. 2. That is, it is assumed that the allocation result determination device is implemented by the first allocation result acquiring circuit 21, the second allocation result acquiring circuit 22, the change cost calculating circuit 23, the reward value difference predicting circuit 24, and the allocation result selecting circuit 27.

Each of the first allocation result acquiring circuit 21, the second allocation result acquiring circuit 22, the change cost calculating circuit 23, the reward value difference predicting circuit 24, and the allocation result selecting circuit 27 is, for example, a single circuit, a composite circuit, a programmed processor, a parallel programmed processor, an application specific integrated circuit (ASIC), a field-programmable gate array (FPGA), or a combination of some of these circuits.

The components of the allocation result determination device are not limited to be implemented by dedicated hardware, and the allocation result determination device may be implemented by software, firmware, or a combination of software and firmware.

Software or firmware is stored in a memory of a computer as a program. The computer means hardware that executes the program, and may be, for example, a central processing unit (CPU), central processor, processing unit, computing unit, microprocessor, microcomputer, processor, or digital signal processor (DSP).

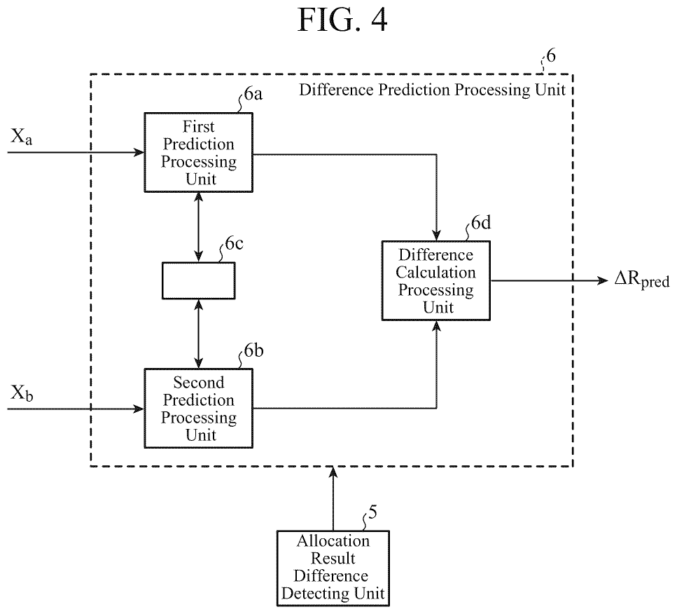

FIG. 3 is a hardware configuration diagram of a computer in a case where the allocation result determination device is implemented by software, firmware, or the like.

In a case where the allocation result determination device is implemented by software, firmware, or the like, a program for causing the computer to execute the processing procedures performed by the first allocation result acquiring unit 1, the second allocation result acquiring unit 2, the change cost calculating unit 3, the reward value difference predicting unit 4, and the allocation result selecting unit 7 is stored in a memory 41. Then, a processor 42 of the computer executes the program stored in the memory 41.

Further, FIG. 2 illustrates an example in which each of the components of the allocation result determination device is implemented by dedicated hardware, and FIG. 3 illustrates an example in which the allocation result determination device is implemented by software, firmware, or the like. However, this is merely an example, and some components in the allocation result determination device may be implemented by dedicated hardware, and the remaining components may be implemented by software, firmware, or the like.

FIG. 4 is a configuration diagram illustrating the difference prediction processing unit 6 of the allocation result determination device according to the first embodiment.

The difference prediction processing unit 6 illustrated in FIG. 4 includes a first prediction processing unit 6a, a second prediction processing unit 6b, the learning model 6c for reward value prediction, and a difference calculation processing unit 6d.

When the difference information d_{ab} output from the allocation result difference detecting unit 5 indicates that there is a difference, the first prediction processing unit 6a gives the first allocation result Xₐ output from the first allocation result acquiring unit 1 to the learning model 6c for reward value prediction, and acquires the first reward value R_{preda} from the learning model 6c.

The first prediction processing unit 6a outputs the first reward value R_{preda} to the difference calculation processing unit 6d.

When the difference information d_{ab} output from the allocation result difference detecting unit 5 indicates that there is a difference, the second prediction processing unit 6b gives the second allocation result X_{b} output from the second allocation result acquiring unit 2 to the learning model 6c for reward value prediction, and acquires the second reward value R_{predb} from the learning model 6c.

The second prediction processing unit 6b outputs the second reward value R_{predb} to the difference calculation processing unit 6d.

The learning model 6c for reward value prediction is given the allocation result X as input data, is given the reward value R_{pred} as training data, and learns the reward value R_{pred} at the time of learning. For example, the reward value R_{pred} is a small value when the cost at the time of selecting the allocation result X is high, and is a large value when the cost at the time of selecting the allocation result X is low.

When being given the first allocation result Xₐ or the second allocation result X_{b}, the learning model 6c outputs the first reward value R_{preda} corresponding to the first allocation result Xₐ or the second reward value R_{predb} corresponding to the second allocation result X_{b} at the time of inference.

Here, the learning model 6c learns by supervised learning. However, this is merely an example, and the learning model 6c may learn by, for example, unsupervised learning, reinforcement learning, or a mathematical optimization method.

The difference calculation processing unit 6d subtracts the first reward value R_{preda} from the second reward value R_{predb} to calculate a reward value difference ΔR_{pred} between the first reward value R_{preda} and the second reward value R_{predb}.

The difference calculation processing unit 6d outputs the reward value difference ΔR_{pred} to the allocation result selecting unit 7.

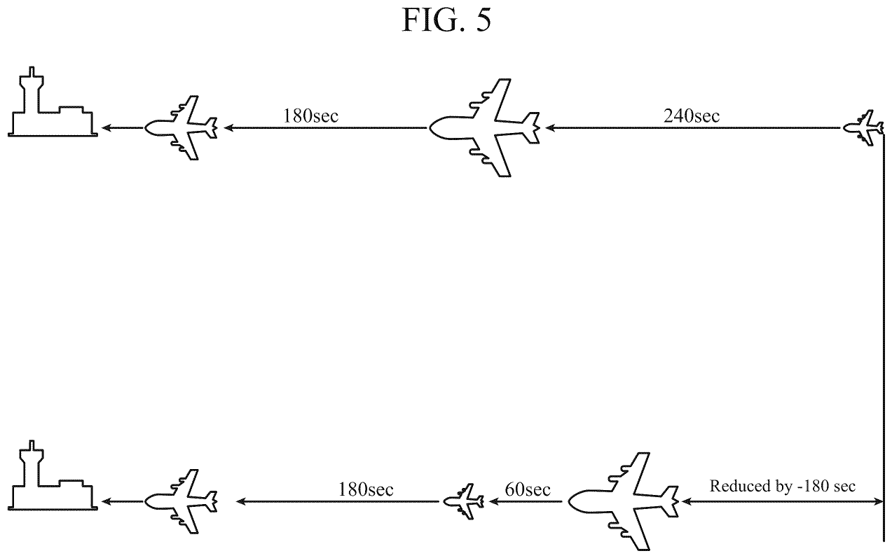

FIG. 5 is an explanatory diagram illustrating an example of an allocation result indicating an allocation order of landing of three airplanes.

In the example of FIG. 5, the three airplanes are a small airplane, a medium airplane, and a large airplane.

In the example of FIG. 5, the landing prohibition time after the small airplane lands is 60 [sec], the landing prohibition time after the medium airplane lands is 180 [sec], and the landing prohibition time after the large airplane lands is 240 [sec].

In a case where landing is permitted for the medium airplane, the large airplane, and the small airplane in this order, the shortest time until all the three airplanes land is 420 (=180+240) [sec] as illustrated in FIG. 5.

In a case where landing is permitted for the medium airplane, the small airplane, and the large airplane in this order, the shortest time until all the three airplanes land is 240 (=180+60) [sec] as illustrated in FIG. 5.

Therefore, the shortest time until all of the airplanes land is shorter by 180 (=420-240) [sec] when landing is permitted for the medium airplane, the small airplane, and the large airplane in this order than when landing is permitted for the medium airplane, the large airplane, and the small airplane in this order.

Next, the operation of the allocation result determination device illustrated in FIG. 1 will be described.

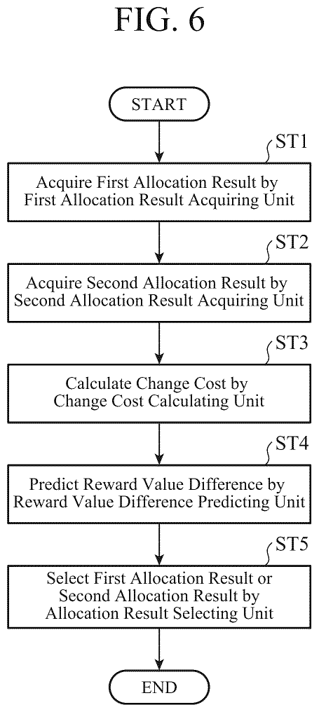

FIG. 6 is a flowchart illustrating an allocation result determination method which is a processing procedure performed by the allocation result determination device illustrated in FIG. 1.

The first allocation result acquiring unit 1 acquires the schedule information Sₐ of the plurality of aircrafts at the first time.

The schedule information Sₐ includes, for example, information indicating an estimated time of landing of each aircraft or an estimated time of take-off of each aircraft, and the size of each aircraft.

The first allocation result acquiring unit 1 gives the schedule information Sₐ to the first learning model 1a, and acquires the first allocation result Xₐ from the first learning model 1a (step ST1 in FIG. 6).

The first allocation result acquiring unit 1 outputs the first allocation result Xₐ to each of the change cost calculating unit 3, the reward value difference predicting unit 4, and the allocation result selecting unit 7.

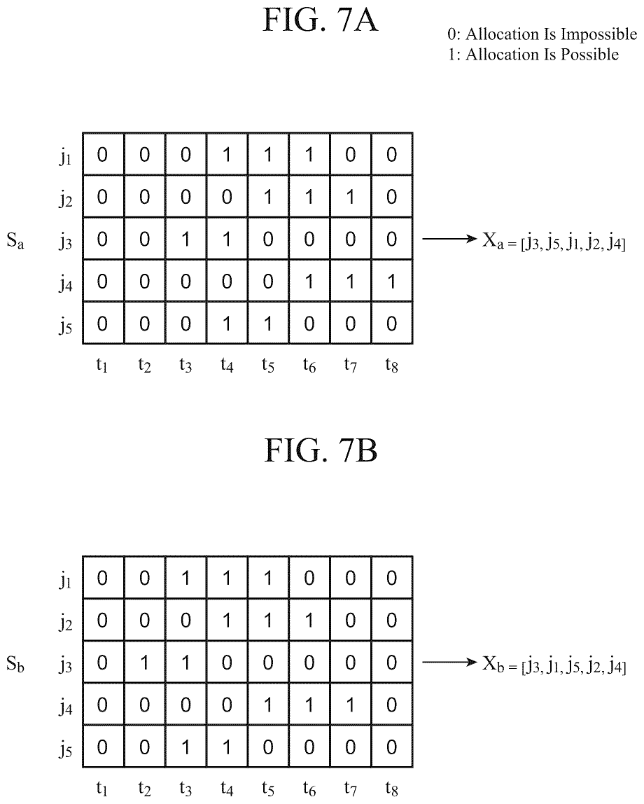

FIG. 7A is an explanatory diagram illustrating an example of the first allocation result Xₐ acquired by the first allocation result acquiring unit 1 when the schedule information Sₐ is given to the first allocation result acquiring unit 1.

In FIG. 7A, t₁, t₂, . . . , and t₈ are times, and j₁, j₂, . . . , and j₅ are identifications (IDs) for identifying the aircraft.

“0” indicates that it is not possible to allocate take-off and landing of the aircraft, and “1” indicates that it is possible to allocate take-off and landing of the aircraft.

In the example of FIG. 7A, the first allocation result Xₐ for permitting take-off and landing of the aircraft j₃, the aircraft j₅, the aircraft j₁, the aircraft j₂, and the aircraft j₄ in this order is obtained.

The second allocation result acquiring unit 2 acquires the schedule information S_{b} of the plurality of aircrafts at the second time later than the first time.

The schedule information S_{b} includes, for example, information indicating an estimated time of landing of each aircraft or an estimated time of take-off of each aircraft, and the size of each aircraft.

The second allocation result acquiring unit 2 gives the schedule information S_{b} to the second learning model 2a, and acquires the second allocation result X_{b} from the second learning model 2a (step ST2 in FIG. 6).

The second allocation result acquiring unit 2 outputs the second allocation result X_{b} to each of the change cost calculating unit 3, the reward value difference predicting unit 4, and the allocation result selecting unit 7.

FIG. 7B is an explanatory diagram illustrating an example of the second allocation result X_{b} acquired by the second allocation result acquiring unit 2 when the schedule information S_{b} is given to the second allocation result acquiring unit 2.

In FIG. 7B, t₁, t₂, . . . , and t₈ are also times, and j₁, j₂, . . . , and j₅ are also IDs for identifying the aircraft.

“0” indicates that it is not possible to allocate take-off and landing of the aircraft, and “1” indicates that it is possible to allocate take-off and landing of the aircraft.

In the example of FIG. 7B, the second allocation result X_{b} for permitting take-off and landing of the aircraft j₃, the aircraft j₁, the aircraft j₅, the aircraft j₂, and the aircraft j₄ in this order is obtained.

The change cost calculating unit 3 acquires the first allocation result Xₐ from the first allocation result acquiring unit 1, and acquires the second allocation result X_{b} from the second allocation result acquiring unit 2.

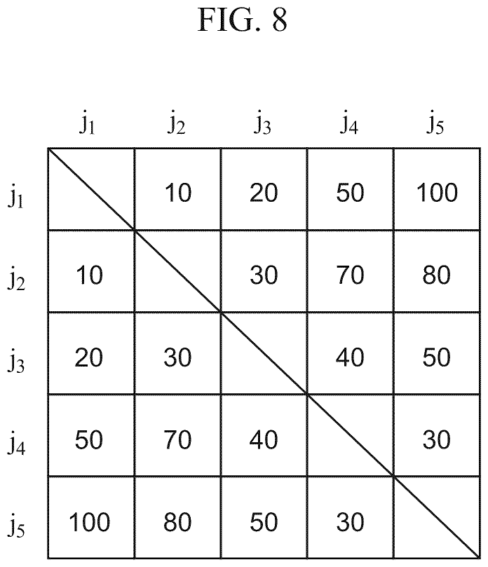

The change cost calculating unit 3 calculates a change cost C_{ab} which is an amount of increase in cost when the allocation result is changed from the first allocation result Xₐ to the second allocation result X_{b} by referring to, for example, a change cost table as illustrated in FIG. 8 (step ST3 in FIG. 6).

The change cost calculating unit 3 outputs the change cost C_{ab} to the allocation result selecting unit 7.

FIG. 8 is an explanatory diagram illustrating an example of the change cost table.

In FIG. 8, j₁, j₂, . . . , j₅ are each an identification symbol indicating an aircraft. Numbers in the table indicate change costs.

For example, in a case where the first allocation result is Xₐ=[j₃, j₅, j₁, j₂, j₄] and the second allocation result is X_{b}=[j₃, j₁, j₅, j₂, j₄], the order of the aircraft j₅ and the aircraft j₁ is switched. Therefore, the change cost C_{ab} is “100”.

For example, in a case where the first allocation result is Xₐ=[j₃, j₅, j₁, j₂, j₄] and the second allocation result is X_{b}=[j₃, j₂, j₅, j₁, j₄], the order of the aircraft j₅ and the aircraft j₂ is switched, and further, the order of the aircraft j₅ and the aircraft j₁ is switched. Therefore, the change cost C_{ab} is “180” (=80+100).

In the allocation result determination device illustrated in FIG. 1, the change cost calculating unit 3 calculates the change cost C_{ab} by referring to the change cost table as illustrated in FIG. 8. However, this is merely an example, and the change cost calculating unit 3 may calculate the change cost C_{ab} as follows, for example.

First, the change cost calculating unit 3 calculates an allocation difference ΔX by subtracting the first allocation result Xₐ from a second allocation result X_{b}′ as expressed by Expression (1) below. X_{b}′ is obtained by matching the time of the second allocation result X_{b} with the time of the first allocation result Xₐ. For example, in a case where the times of the first allocation result Xₐ are t₁, t₂, . . . , and t₈, and the times of the second allocation result X_{b} are t₃, t₄, . . . , and t₁₀, it is assumed that the time t₃ of the second allocation result X_{b} is t₁, the time t₄ is t₂, and the time t₁₀ is t₈.

$$Δ X = {X}_{b}^{′} - {X}_{a} \qquad ( 1 )$$

Next, the change cost calculating unit 3 substitutes the allocation difference ΔX into Expression (2) below to calculate a change cost C₀ associated with a change in order.

In addition, the change cost calculating unit 3 substitutes the allocation difference ΔX into Expression (3) below to calculate a change cost C₁ associated with the change in time.

$${C}_{o} = {γ}_{o} [ g ( j ) ⊙ ( 1 - {d}_{ab} ) ] \cdot \vert Δ X \vert \qquad ( 2 )$$

$${C}_{t} = {γ}_{t} [ g ( j ) ⊙ ( 1 - {d}_{ab} ) ] \cdot Δ {X}^{2} \qquad ( 3 )$$

In Expressions (2) and (3), ⊙ is a mathematical symbol representing an inner product.

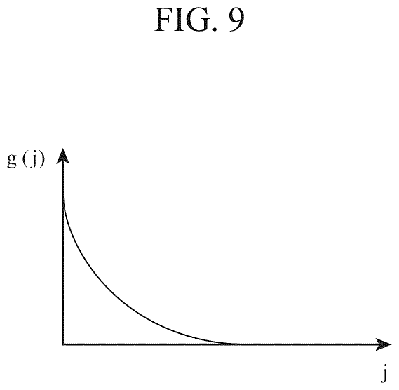

g(j) is an attenuation function as illustrated in FIG. 9, and for example, g(j)=e^{(-j/T)}. j is an ID for identifying an aircraft, and T is a time constant.

d_{ab} is the difference information d_{ab} output from the allocation result difference detecting unit 5 to the change cost calculating unit 3. FIG. 1 does not illustrate arrows from the allocation result difference detecting unit 5 to the change cost calculating unit 3. When there is no difference between the schedule information Sₐ and the schedule information S_{b}, d_{ab}=0, and when there is a difference between the schedule information Sₐ and the schedule information S_{b}, d_{ab}=1.

Each of γ₀ and γₜ is a coefficient.

The change cost calculating unit 3 calculates the change cost C_{ab} by performing weighted addition on the change cost C₀ associated with the change in order and the change cost C₁ associated with the change in time as expressed in Expression (4) below.

$${C}_{ab} = {C}_{0} + w \cdot {C}_{t} \qquad ( 4 )$$

In Expression (4), w is a weighting factor.

The reward value difference predicting unit 4 predicts the reward value difference ΔR_{pred} (step ST4 in FIG. 6).

The prediction processing of predicting the reward value difference ΔR_{pred} by the reward value difference predicting unit 4 will be specifically described below.

The allocation result difference detecting unit 5 of the reward value difference predicting unit 4 acquires the schedule information Sₐ at the first time and the schedule information S_{b} at the second time.

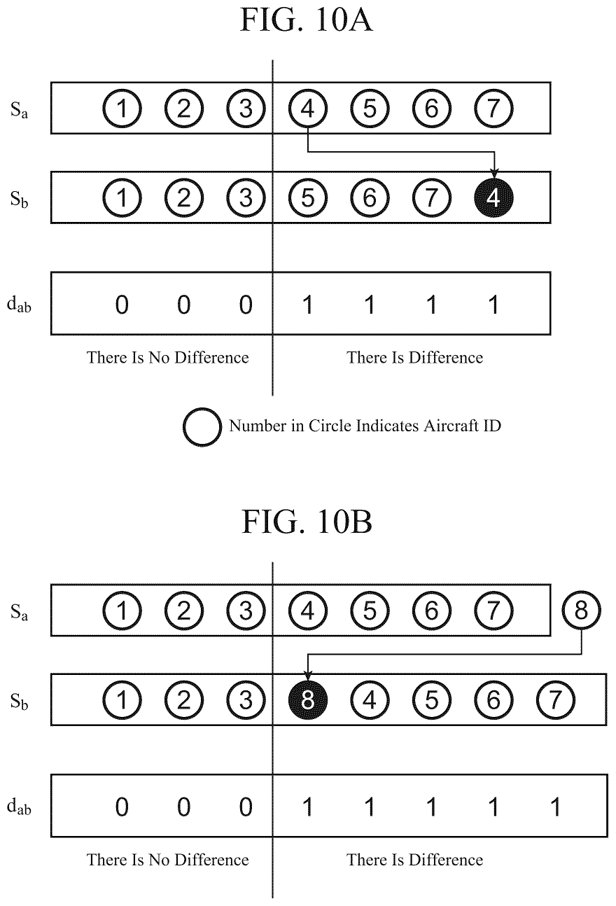

The allocation result difference detecting unit 5 detects a difference between the schedule information Sₐ and the schedule information S_{b} as illustrated in FIG. 10, and outputs difference information d_{ab} indicating the difference to the difference prediction processing unit 6. When the change cost calculating unit 3 calculates the change cost C_{ab} by Expression (4), the allocation result difference detecting unit 5 also outputs the difference information d_{ab} to the change cost calculating unit 3.

FIG. 10A is an explanatory diagram illustrating the difference information d_{ab} in a case where the allocation order of the aircraft j₄ is changed from the fourth position counted from the top to the last.

FIG. 10B is an explanatory diagram illustrating the difference information d_{ab} in a case where the aircraft j₈ that is not included in the schedule information Sₐ is included in the schedule information S_{b}.

In FIGS. 10A and 10B, the number in each circle is an ID for identifying the aircraft. Note that the symbol j is omitted.

When there is no difference between the schedule information Sₐ and the schedule information S_{b}, d_{ab}=0, and when there is a difference between the schedule information Sₐ and the schedule information S_{b}, d_{ab}=1.

The first prediction processing unit 6a of the difference prediction processing unit 6 acquires the first allocation result Xₐ from the first allocation result acquiring unit 1, and acquires the difference information d_{ab} from the allocation result difference detecting unit 5.

When the difference information d_{ab} is “1”, the first prediction processing unit 6a gives the first allocation result Xₐ to the learning model 6c for reward value prediction, and acquires the first reward value R_{preda} from the learning model 6c.

The first prediction processing unit 6a outputs the first reward value R_{preda} to the difference calculation processing unit 6d.

The second prediction processing unit 6b of the difference prediction processing unit 6 acquires the second allocation result X_{b} from the second allocation result acquiring unit 2, and acquires the difference information d_{ab} from the allocation result difference detecting unit 5.

When the difference information d_{ab} is “1”, the second prediction processing unit 6b gives the second allocation result X_{b} to the learning model 6c for reward value prediction, and acquires the second reward value R_{predb} from the learning model 6c.

The second prediction processing unit 6b outputs the second reward value R_{predb} to the difference calculation processing unit 6d.

The difference calculation processing unit 6d acquires the first reward value R_{preda} from the first prediction processing unit 6a and acquires the second reward value R_{predb} from the second prediction processing unit 6b.

The difference calculation processing unit 6d subtracts the first reward value R_{preda} from the second reward value R_{predb} to calculate a reward value difference ΔR_{pred} between the first reward value R_{preda} and the second reward value R_{predb} as represented by Expression (5) below. In a case where the reward value difference ΔR_{pred} is a negative value, the cost when the second allocation result X_{b} is selected is higher than the cost when the first allocation result Xₐ is selected. In a case where the reward value difference ΔR_{pred} is a positive value, the cost when the second allocation result X_{b} is selected is lower than the cost when the first allocation result Xₐ is selected.

$$Δ {R}_{pred} = {R}_{predb} - {R}_{preda} \qquad ( 5 )$$

The difference calculation processing unit 6d outputs the reward value difference ΔR_{pred} to the allocation result selecting unit 7.

The allocation result selecting unit 7 acquires the first allocation result Xₐ from the first allocation result acquiring unit 1, and acquires the second allocation result X_{b} from the second allocation result acquiring unit 2.

The allocation result selecting unit 7 selects the first allocation result Xₐ or the second allocation result X_{b} on the basis of the change cost C_{ab} calculated by the change cost calculating unit 3 and the reward value difference ΔR_{pred} predicted by the reward value difference predicting unit 4 (step ST5 in FIG. 6).

That is, the allocation result selecting unit 7 selects the second allocation result X_{b} when the reward value difference ΔR_{pred} predicted by the reward value difference predicting unit 4 is larger than 0 and the change cost C_{ab} is equal to or less than the cost threshold Thc.

The allocation result selecting unit 7 selects the first allocation result Xₐ when the reward value difference ΔR_{pred} is equal to or less than 0 or the change cost C_{ab} is larger than the cost threshold Thc.

In the allocation result determination device illustrated in FIG. 1, the allocation result selecting unit 7 selects the first allocation result Xₐ or the second allocation result X_{b} on the basis of the change cost C_{ab} and the reward value difference ΔR_{pred}. However, this is merely an example. The allocation result selecting unit 7 may select the first allocation result Xₐ or the second allocation result X_{b} on the basis of only the change cost C_{ab}. In a case where the allocation result selecting unit 7 selects the first allocation result Xₐ or the second allocation result X_{b} on the basis of only the change cost C_{ab}, the allocation result determination device does not need to include the reward value difference predicting unit 4.

Alternatively, the allocation result selecting unit 7 may select the first allocation result Xₐ or the second allocation result X_{b} on the basis of only the reward value difference ΔR_{pred}. In a case where the allocation result selecting unit 7 selects the first allocation result Xₐ or the second allocation result X_{b} on the basis of only the reward value difference ΔR_{pred}, the allocation result determination device does not need to include the change cost calculating unit 3.

In the first embodiment described above, the allocation result determination device includes the change cost calculating unit 3 that acquires the first allocation result determined at the first time and the second allocation result determined at the second time later than the first time as the allocation result indicating the allocation order for the plurality of objects to be allocated, and calculates a change cost that is an amount of increase in cost when the allocation result is changed from the first allocation result to the second allocation result. The allocation result determination device also includes the allocation result selecting unit 7 that selects the first allocation result or the second allocation result on the basis of the change cost calculated by the change cost calculating unit 3. Therefore, the allocation result determination device can select the first allocation result or the second allocation result on the basis of cost when the second allocation result is determined after the first allocation result is determined as the allocation result indicating the allocation order for the plurality of objects to be allocated.

### Second Embodiment

In the second embodiment, it will be described an allocation result determination device including a reward value difference predicting unit 9 that updates a learning model 10c.

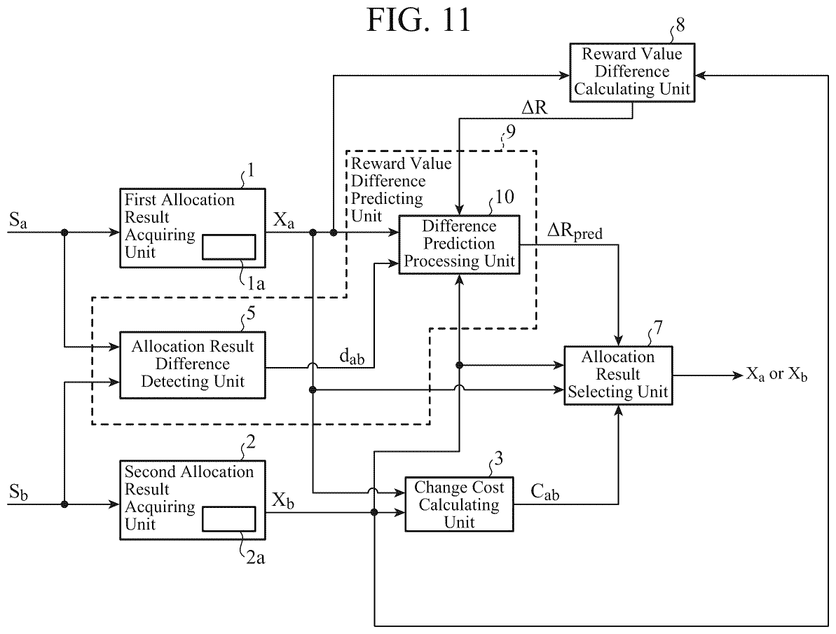

FIG. 11 is a configuration diagram illustrating the allocation result determination device according to the second embodiment. In FIG. 11, elements same as or corresponding to the elements in FIG. 1 are identified by the same reference numerals, and thus, the description thereof will be omitted.

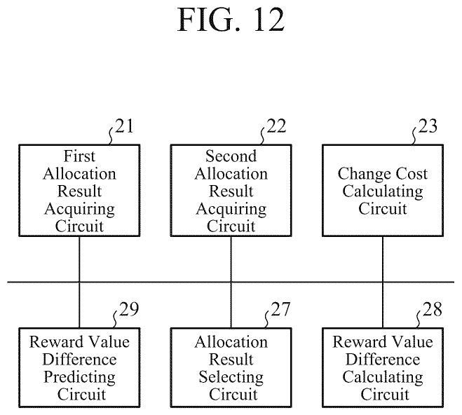

FIG. 12 is a hardware configuration diagram illustrating hardware of the allocation result determination device according to the second embodiment. In FIG. 12, elements same as or corresponding to the elements in FIG. 2 are identified by the same reference numerals, and thus, the description thereof will be omitted.

The allocation result determination device illustrated in FIG. 11 includes a first allocation result acquiring unit 1, a second allocation result acquiring unit 2, a change cost calculating unit 3, a reward value difference predicting unit 9, an allocation result selecting unit 7, and a reward value difference calculating unit 8.

The reward value difference calculating unit 8 is implemented by, for example, a reward value difference calculating circuit 28 illustrated in FIG. 12.

The reward value difference calculating unit 8 gives a first allocation result Xₐ to a reward function to calculate a first reward value Rₐ, and gives a second allocation result X_{b} to the reward function to calculate a second reward value R_{b}.

The reward value difference calculating unit 8 subtracts the first reward value Rₐ from the second reward value R_{b} to calculate a reward value difference ΔR between the first reward value Rₐ and the second reward value R_{b}.

The reward value difference calculating unit 8 outputs the reward value difference ΔR to the reward value difference predicting unit 9.

The reward value difference predicting unit 9 is implemented by, for example, a reward value difference predicting circuit 29 illustrated in FIG. 12.

The reward value difference predicting unit 9 includes an allocation result difference detecting unit 5 and a difference prediction processing unit 10.

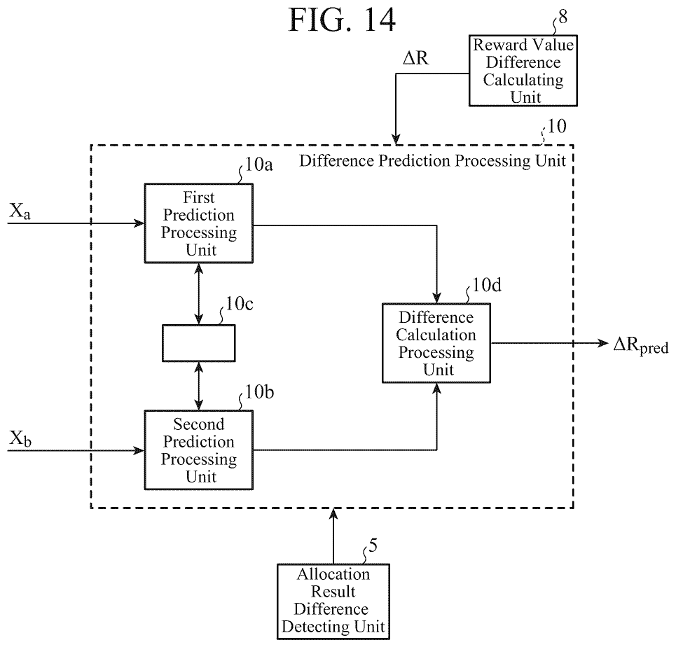

The reward value difference predicting unit 9 gives each of the first allocation result Xₐ and the second allocation result X_{b} to the learning model 10c for reward value prediction illustrated in FIG. 14, and acquires, from the learning model 10c, a first reward value R_{preda} indicating a degree of quality of the first allocation result Xₐ and a second reward value R_{predb} indicating a degree of quality of the second allocation result X_{b}.

The reward value difference predicting unit 9 subtracts the first reward value R_{preda} from the second reward value R_{predb} to predict a reward value difference ΔR_{pred} between the first reward value R_{preda} and the second reward value R_{predb}.

The reward value difference predicting unit 9 outputs the reward value difference ΔR_{pred} to the allocation result selecting unit 7.

In addition, the reward value difference predicting unit 9 updates the learning model 10c so as to reduce a difference between the predicted reward value difference ΔR_{pred} and the reward value difference ΔR calculated by the reward value difference calculating unit 8.

FIG. 11 illustrates an example in which the first allocation result acquiring unit 1, the second allocation result acquiring unit 2, the change cost calculating unit 3, the reward value difference predicting unit 9, the allocation result selecting unit 7, and the reward value difference calculating unit 8, which are components of the allocation result determination device, are each implemented by dedicated hardware as illustrated in FIG. 12. That is, it is assumed that the allocation result determination device is implemented by the first allocation result acquiring circuit 21, the second allocation result acquiring circuit 22, the change cost calculating circuit 23, the reward value difference predicting circuit 29, the allocation result selecting circuit 27, and the reward value difference calculating circuit 28.

Each of the first allocation result acquiring circuit 21, the second allocation result acquiring circuit 22, the change cost calculating circuit 23, the reward value difference predicting circuit 29, the allocation result selecting circuit 27, and the reward value difference calculating circuit 28 is, for example, a single circuit, a composite circuit, a programmed processor, a parallel programmed processor, an ASIC, a FPGA, or a combination of some of these circuits.

The components of the allocation result determination device are not limited to be implemented by dedicated hardware, and the allocation result determination device may be implemented by software, firmware, or a combination of software and firmware.

In a case where the allocation result determination device is implemented by software, firmware, or the like, a program for causing a computer to execute the processing procedures performed by the first allocation result acquiring unit 1, the second allocation result acquiring unit 2, the change cost calculating unit 3, the reward value difference predicting unit 9, the allocation result selecting unit 7, and the reward value difference calculating unit 8 is stored in the memory 41 illustrated in FIG. 3. Then, the processor 42 illustrated in FIG. 3 executes the program stored in the memory 41.

Further, FIG. 12 illustrates an example in which each of the components of the allocation result determination device is implemented by dedicated hardware, and FIG. 3 illustrates an example in which the allocation result determination device is implemented by software, firmware, or the like. However, this is merely an example, and some components in the allocation result determination device may be implemented by dedicated hardware, and the remaining components may be implemented by software, firmware, or the like.

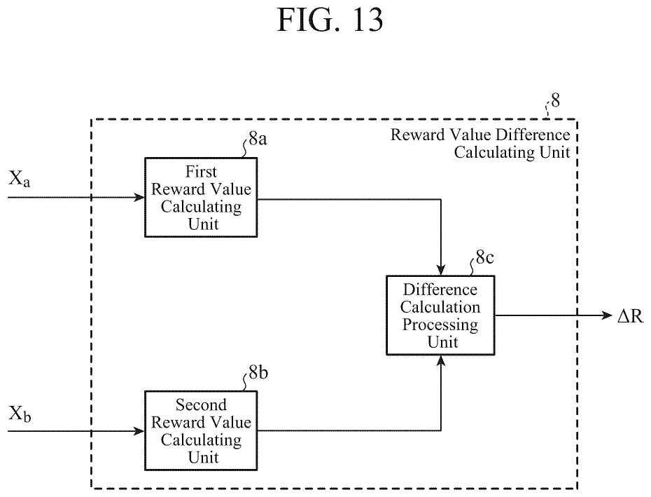

FIG. 13 is a configuration diagram illustrating the reward value difference calculating unit 8 of the allocation result determination device according to the second embodiment.

The reward value difference calculating unit 8 illustrated in FIG. 13 includes a first reward value calculating unit 8a, a second reward value calculating unit 8b, and a difference calculation processing unit 8c.

The first reward value calculating unit 8a acquires the first allocation result Xₐ from the first allocation result acquiring unit 1.

The first reward value calculating unit 8a gives the first allocation result Xₐ to a reward function to calculate the first reward value Rₐ, and outputs the first reward value Rₐ to the difference calculation processing unit 8c.

The second reward value calculating unit 8b acquires the second allocation result X_{b} from the second allocation result acquiring unit 2.

The second reward value calculating unit 8b gives the second allocation result X_{b} to the reward function to calculate the second reward value R_{b}, and outputs the second reward value R_{b} to the difference calculation processing unit 8c.

The difference calculation processing unit 8c acquires the first reward value Rₐ from the first reward value calculating unit 8a and acquires the second reward value R_{b} from the second allocation result acquiring unit 2.

The difference calculation processing unit 8c subtracts the first reward value Rₐ from the second reward value R_{b} to calculate a reward value difference ΔR between the first reward value Rₐ and the second reward value R_{b}.

The difference calculation processing unit 8c outputs the reward value difference ΔR to the reward value difference predicting unit 9.

FIG. 14 is a configuration diagram illustrating the difference prediction processing unit 10 of the allocation result determination device according to the second embodiment.

The difference prediction processing unit 10 illustrated in FIG. 14 includes a first prediction processing unit 10a, a second prediction processing unit 10b, a learning model 10c for reward value prediction, and a difference calculation processing unit 10d.

When the difference information d_{ab} output from the allocation result difference detecting unit 5 indicates that there is a difference, the first prediction processing unit 10a gives the first allocation result Xₐ output from the first allocation result acquiring unit 1 to the learning model 10c for reward value prediction, and acquires the first reward value R_{preda} from the learning model 10c.

The first prediction processing unit 10a outputs the first reward value R_{preda} to the difference calculation processing unit 10d.

When the difference information d_{ab} output from the allocation result difference detecting unit 5 indicates that there is a difference, the second prediction processing unit 10b gives the second allocation result X_{b} output from the second allocation result acquiring unit 2 to the learning model 10c for reward value prediction, and acquires the second reward value R_{predb} from the learning model 10c.

The second prediction processing unit 10b outputs the second reward value R_{predb} to the difference calculation processing unit 10d.

The learning model 10c for reward value prediction is given the allocation result X as input data, is given the reward value R_{pred} as training data, and learns the reward value R_{pred} at the time of learning.

When being given the first allocation result Xₐ or the second allocation result X_{b}, the learning model 10c outputs the first reward value R_{preda} corresponding to the first allocation result Xₐ or the second reward value R_{predb} corresponding to the second allocation result X_{b} at the time of inference.

Here, the learning model 10c learns by supervised learning. However, this is merely an example, and the learning model 10c may learn by, for example, unsupervised learning, reinforcement learning, or a mathematical optimization method.

The difference calculation processing unit 10d subtracts the first reward value R_{preda} from the second reward value R_{predb} to calculate a reward value difference ΔR_{pred} between the first reward value R_{preda} and the second reward value R_{predb}.

Next, the operation of the allocation result determination device illustrated in FIG. 11 will be described. Note that the allocation result determination device is similar to the allocation result determination device illustrated in FIG. 1 except for the reward value difference calculating unit 8 and the reward value difference predicting unit 9. Therefore, only the operations of the reward value difference calculating unit 8 and the reward value difference predicting unit 9 will be described here.

The first reward value calculating unit 8a of the reward value difference calculating unit 8 acquires the first allocation result Xₐ from the first allocation result acquiring unit 1.

The first reward value calculating unit 8a gives the first allocation result Xₐ to a reward function represented by Expression (6) below to calculate the first reward value Rₐ.

$${R}_{a} = {R}_{assigna} + α \cdot {R}_{separationa} \qquad ( 6 )$$

In Expression (6), R_{assigna} is an evaluation value for evaluating whether or not the allocation time of each aircraft is an appropriate time. R_{assigna} is a value determined by the first allocation result Xₐ, and has a larger value as the allocation time of each aircraft is earlier within a time range in which allocation is possible.

Rₛₑₚₐᵣₐₜᵢₒₙₐ is an evaluation value related to an allocation interval of a plurality of aircrafts. Rₛₑₚₐᵣₐₜᵢₒₙₐ is a value determined by the first allocation result Xₐ, and when the allocation interval is larger than the minimum interval in which the allocation is possible, Rₛₑₚₐᵣₐₜᵢₒₙₐ has a larger value as the allocation interval is smaller.

α is a weighting factor.

The first reward value calculating unit 8a outputs the first reward value Rₐ to the difference calculation processing unit 8c.

The second reward value calculating unit 8b acquires the second allocation result X_{b} from the second allocation result acquiring unit 2.

The second reward value calculating unit 8b gives the second allocation result X_{b} to a reward function represented by Expression (7) below to calculate the second reward value R_{b}.

$${R}_{b} = {R}_{assignb} + β \cdot {R}_{separationb} \qquad ( 7 )$$

In Expression (7), R_{assignb} is an evaluation value for evaluating whether or not the allocation time of each aircraft is an appropriate time. R_{assignb} is a value determined by the second allocation result X_{b}, and has a larger value as the allocation time of each aircraft is earlier within a time range in which allocation is possible.

R_{separationb} is an evaluation value related to an allocation interval of a plurality of aircrafts. R_{separationb} is a value determined by the second allocation result X_{b}, and when the allocation interval is larger than the minimum interval in which the allocation is possible, R_{separationb} has a larger value as the allocation interval is smaller.

β is a weighting factor.

The second reward value calculating unit 8b outputs the second reward value R_{b} to the difference calculation processing unit 8c.

The difference calculation processing unit 8c acquires the first reward value Rₐ from the first reward value calculating unit 8a and acquires the second reward value R_{b} from the second allocation result acquiring unit 2.

The difference calculation processing unit 8c subtracts the first reward value Rₐ from the second reward value R_{b} to calculate a reward value difference ΔR between the first reward value Rₐ and the second reward value R_{b} as represented by Expression (8) below.

$$Δ {R}_{pred} = {R}_{b} - {R}_{a} \qquad ( 8 )$$

The difference calculation processing unit 8c outputs the reward value difference ΔR to the difference prediction processing unit 10 of the reward value difference predicting unit 9.

The first prediction processing unit 10a of the difference prediction processing unit 10 acquires the first allocation result Xₐ from the first allocation result acquiring unit 1, and acquires the difference information d_{ab} from the allocation result difference detecting unit 5.

When the difference information d_{ab} is “1”, the first prediction processing unit 10a gives the first allocation result Xₐ to the learning model 10c for reward value prediction, and acquires the first reward value R_{preda} from the learning model 10c.

The first prediction processing unit 10a outputs the first reward value R_{preda} to the difference calculation processing unit 10d.

The second prediction processing unit 10b acquires the second allocation result X_{b} from the second allocation result acquiring unit 2, and acquires the difference information d_{ab} from the allocation result difference detecting unit 5.

When the difference information d_{ab} is “1”, the second prediction processing unit 10b gives the second allocation result X_{b} to the learning model 10c for reward value prediction, and acquires the second reward value R_{predb} from the learning model 10c.

The second prediction processing unit 10b outputs the second reward value R_{predb} to the difference calculation processing unit 10d.

The difference calculation processing unit 10d acquires the first reward value R_{preda} from the first prediction processing unit 10a and acquires the second reward value R_{predb} from the second prediction processing unit 10b.

The difference calculation processing unit 10d subtracts the first reward value R_{preda} from the second reward value R_{predb} to calculate a reward value difference ΔR_{pred} between the first reward value R_{preda} and the second reward value R_{predb} as represented by Expression (5) above.

The difference calculation processing unit 10d outputs the reward value difference ΔR_{pred} to the allocation result selecting unit 7.

Each of the first prediction processing unit 10a and the second prediction processing unit 10b updates the learning model 10c so as to reduce a difference between the reward value difference ΔR_{pred} calculated by the difference calculation processing unit 10d and the reward value difference ΔR calculated by the difference calculation processing unit 8c of the reward value difference calculating unit 8.

Specifically, each of the first prediction processing unit 10a and the second prediction processing unit 10b updates the weight of the learning model 10c in such a way that (ΔR−ΔR_{pred})² is minimized.

In the second embodiment described above, the allocation result determination device illustrated in FIG. 11 includes the reward value difference calculating unit 8 that gives the first allocation result to the reward function to calculate the first reward value, gives the second allocation result to the reward function to calculate the second reward value, and calculates the reward value difference between the first reward value and the second reward value by subtracting the first reward value from the second reward value. In addition, in the allocation result determination device illustrated in FIG. 11, the reward value difference predicting unit 9 updates the learning model 10c so as to reduce a difference between the predicted reward value difference and the reward value difference calculated by the reward value difference calculating unit 8. Therefore, the allocation result determination device illustrated in FIG. 11 can enhance the accuracy of selecting the allocation result as compared with the allocation result determination device illustrated in FIG. 1.

### Third Embodiment

In the third embodiment, it will be described an allocation result determination device including a penalty value calculating unit 11.

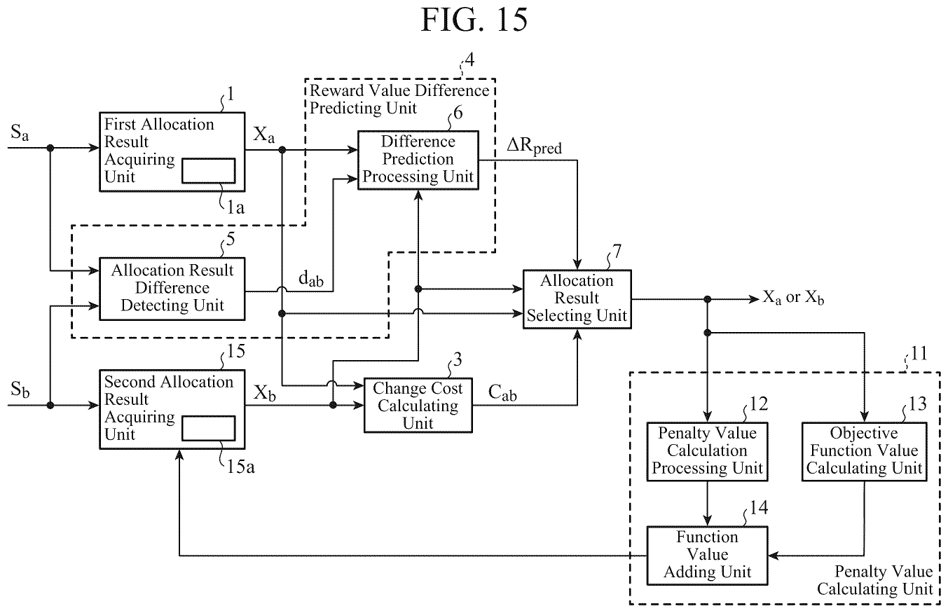

FIG. 15 is a configuration diagram illustrating the allocation result determination device according to the third embodiment. In FIG. 15, elements same as or corresponding to the elements in FIG. 1 are identified by the same reference numerals, and thus, the description thereof will be omitted.

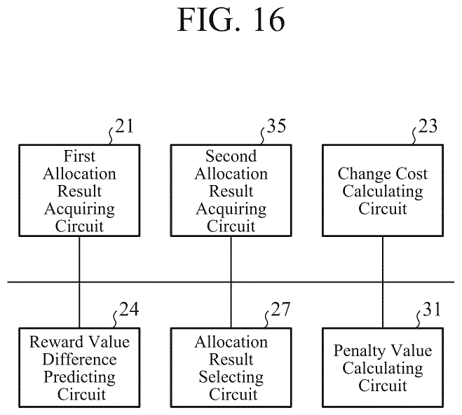

FIG. 16 is a hardware configuration diagram illustrating hardware of the allocation result determination device according to the third embodiment. In FIG. 16, elements same as or corresponding to the elements in FIG. 2 are identified by the same reference numerals, and thus, the description thereof will be omitted.

The allocation result determination device illustrated in FIG. 15 includes a first allocation result acquiring unit 1, a second allocation result acquiring unit 15, a change cost calculating unit 3, a reward value difference predicting unit 4, an allocation result selecting unit 7, and a penalty value calculating unit 11.

The penalty value calculating unit 11 is implemented by, for example, a penalty value calculating circuit 31 illustrated in FIG. 16.

The penalty value calculating unit 11 includes a penalty value calculation processing unit 12, an objective function value calculating unit 13, and a function value adding unit 14.

When the allocation result selected by the allocation result selecting unit 7 has an allocation violation, the penalty value calculating unit 11 calculates a penalty value for the allocation violation.

The penalty value calculating unit 11 outputs the penalty value to the second allocation result acquiring unit 15.

When the allocation result selected by the allocation result selecting unit 7 has an allocation violation, the penalty value calculation processing unit 12 calculates a penalty value for the allocation violation.

The penalty value calculation processing unit 12 outputs the penalty value to the function value adding unit 14.

The objective function value calculating unit 13 gives the allocation result selected by the allocation result selecting unit 7 to an objective function, and calculates an objective function value that is a value of the objective function.

The objective function value calculating unit 13 outputs the objective function value to the function value adding unit 14.

The function value adding unit 14 adds the objective function value calculated by the objective function value calculating unit 13 to the penalty value calculated by the penalty value calculation processing unit 12.

The function value adding unit 14 outputs the penalty value to which the objective function value has been added to the second allocation result acquiring unit 15.

In the allocation result determination device illustrated in FIG. 15, the penalty value calculating unit 11 includes the penalty value calculation processing unit 12, the objective function value calculating unit 13, and the function value adding unit 14. However, this is merely an example, and for example, the penalty value calculating unit 11 may include only either the penalty value calculation processing unit 12 or the objective function value calculating unit 13. In a case where the penalty value calculating unit 11 includes only the penalty value calculation processing unit 12, the penalty value calculated by the penalty value calculation processing unit 12 is output to the second allocation result acquiring unit 15. In a case where the penalty value calculating unit 11 includes only the objective function value calculating unit 13, the objective function value is output to the second allocation result acquiring unit 15 as a penalty value.

The second allocation result acquiring unit 15 is implemented by, for example, a second allocation result acquiring circuit 35 illustrated in FIG. 16.

The second allocation result acquiring unit 15 gives the schedule information S_{b} at the second time to a second learning model 15a, and acquires the second allocation result X_{b} from the second learning model 15a.

The second allocation result acquiring unit 15 outputs the second allocation result X_{b} to each of the change cost calculating unit 3, the reward value difference predicting unit 4, and the allocation result selecting unit 7.

In addition, the second allocation result acquiring unit 15 updates the second learning model 15a so as to decrease the penalty value calculated by the penalty value calculating unit 11.

At the time of learning, the second learning model 15a is given schedule information S of the plurality of aircrafts as input data, is given an allocation result X indicating the allocation order of take-off and landing of the plurality of aircrafts as training data, and learns the allocation result X.

When being given the schedule information S_{b} of the plurality of aircrafts, the second learning model 15a outputs the second allocation result X_{b} corresponding to the schedule information S_{b} at the time of inference.

Here, the second learning model 15a learns by supervised learning. However, this is merely an example, and the second learning model 15a may learn by, for example, unsupervised learning, reinforcement learning, or a mathematical optimization method.

The allocation result determination device illustrated in FIG. 15 is obtained by applying the second allocation result acquiring unit 15 and the penalty value calculating unit 11 to the allocation result determination device illustrated in FIG. 1. However, this is merely an example, and each of the second allocation result acquiring unit 15 and the penalty value calculating unit 11 may be applied to the allocation result determination device illustrated in FIG. 11.

FIG. 15 illustrates an example in which the first allocation result acquiring unit 1, the second allocation result acquiring unit 15, the change cost calculating unit 3, the reward value difference predicting unit 4, the allocation result selecting unit 7, and the penalty value calculating unit 11, which are components of the allocation result determination device, are each implemented by dedicated hardware as illustrated in FIG. 16. That is, it is assumed that the allocation result determination device is implemented by the first allocation result acquiring circuit 21, the second allocation result acquiring circuit 35, the change cost calculating circuit 23, the reward value difference predicting circuit 24, the allocation result selecting circuit 27, and the penalty value calculating circuit 31.

Each of the first allocation result acquiring circuit 21, the second allocation result acquiring circuit 35, the change cost calculating circuit 23, the reward value difference predicting circuit 24, the allocation result selecting circuit 27, and the penalty value calculating circuit 31 is, for example, a single circuit, a composite circuit, a programmed processor, a parallel programmed processor, an ASIC, a FPGA, or a combination of some of these circuits.

The components of the allocation result determination device are not limited to be implemented by dedicated hardware, and the allocation result determination device may be implemented by software, firmware, or a combination of software and firmware.

In a case where the allocation result determination device is implemented by software, firmware, or the like, a program for causing a computer to execute the processing procedures performed by the first allocation result acquiring unit 1, the second allocation result acquiring unit 15, the change cost calculating unit 3, the reward value difference predicting unit 4, the allocation result selecting unit 7, and the penalty value calculating unit 11 is stored in the memory 41 illustrated in FIG. 3. Then, the processor 42 illustrated in FIG. 3 executes the program stored in the memory 41.

Further, FIG. 16 illustrates an example in which each of the components of the allocation result determination device is implemented by dedicated hardware, and FIG. 3 illustrates an example in which the allocation result determination device is implemented by software, firmware, or the like. However, this is merely an example, and some components in the allocation result determination device may be implemented by dedicated hardware, and the remaining components may be implemented by software, firmware, or the like.

Next, the operation of the allocation result determination device illustrated in FIG. 15 will be described. Note that the allocation result determination device is similar to the allocation result determination device illustrated in FIG. 1 except for the penalty value calculating unit 11 and the second allocation result acquiring unit 15. Therefore, only the operations of the penalty value calculating unit 11 and the second allocation result acquiring unit 15 will be described here.

The penalty value calculation processing unit 12 of the penalty value calculating unit 11 acquires the first allocation result Xₐ or the second allocation result X_{b} as an allocation result Xₛₑₗ selected by the allocation result selecting unit 7.

The penalty value calculation processing unit 12 determines whether or not the allocation time of each aircraft indicated by the allocation result Xₛₑₗ is a time at which allocation is possible.

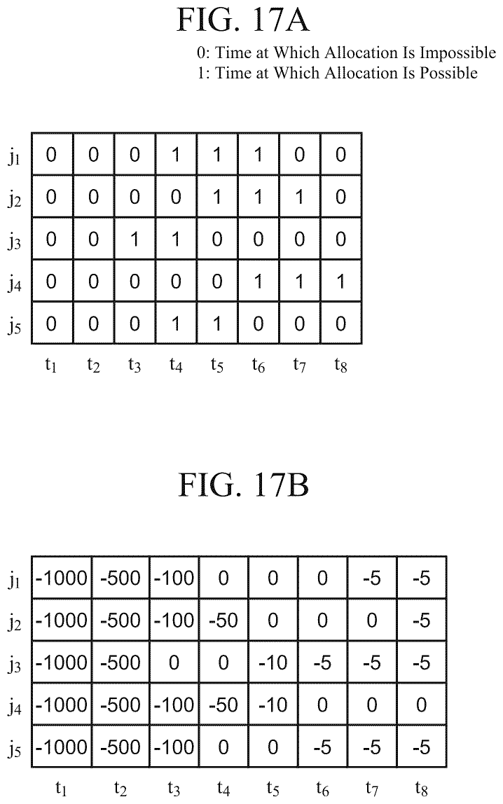

FIG. 17A is an explanatory diagram illustrating times at which allocation is possible and times at which allocation is impossible.

In FIG. 17A, t₁, t₂, . . . , and t₈ are times, and j₁, j₂, . . . , and j₅ are IDs for identifying the aircraft.

“0” indicates a time at which allocation is impossible, and “1” indicates a time at which allocation is possible.

When the allocation time of each aircraft indicated by the allocation result Xₛₑₗ is allocated to the time at which allocation is possible, the allocation result has no allocation violation, and when the allocation time is allocated to the time at which allocation is impossible, the allocation result has an allocation violation.

FIG. 17B is an explanatory diagram illustrating a penalty table.

The penalty table illustrated in FIG. 17B illustrates a penalty value when the allocation time is allocated to a time at which allocation is possible, and a penalty value when the allocation time is allocated to a time at which allocation is impossible.

In the example of FIG. 17B, the penalty value when the allocation time is allocated to a time at which allocation is possible is “0”, and the penalty value when the allocation time is allocated to a time at which allocation is impossible is a negative value.

For example, regarding the penalty value in a case where the allocation time is allocated to a time earlier than the time at which the allocation is possible, the earlier the time to which the allocation time is allocated, the larger the absolute value of the penalty value.

When there is an allocation violation, the penalty value calculation processing unit 12 calculates a penalty value p by referring to the penalty table illustrated in FIG. 17B.

For example, when there is an allocation violation in which the aircraft j₂ is allocated to time t₂ and an allocation violation in which the aircraft j₃ is allocated to time t₅, the penalty value p is −510 (=−500−10).

For example, when there is only an allocation violation in which the aircraft j₅ is allocated to time t₆, the penalty value p is −5.

The penalty value calculation processing unit 12 outputs the penalty value p to the function value adding unit 14.

Here, the penalty value calculation processing unit 12 calculates the penalty value with reference to the penalty table illustrated in FIG. 17B. However, this is merely an example, and for example, the penalty value calculation processing unit 12 may apply the allocation result Xₛₑₗ to a penalty function p(Xₛₑₗ) as represented by Expression (9) below and calculate the penalty value p that is the value of the penalty function p(Xₛₑₗ).

$$p ( {X}_{sel} ) = {\sum }_{j = 1}^{J} {γ}_{j} {e}^{( - \frac{j}{T} )} ( j > 0 ) \qquad ( 9 )$$

In Expression (9), the penalty function p(Xₛₑₗ) is an attenuation function, and is 0 when there is no allocation violation.

γⱼ is a coefficient, and j=j₁, j₂, . . . , J.

The objective function value calculating unit 13 acquires the first allocation result Xₐ or the second allocation result X_{b} as the allocation result Xₛₑₗ selected by the allocation result selecting unit 7.

The objective function value calculating unit 13 gives the allocation result Xₛₑₗ to an objective function f(Xₛₑₗ) as represented by Expression (10) below, and calculates an objective function value f that is a value of the objective function f(Xₛₑₗ).

$$f ( {X}_{sel} ) = {f}_{assign} + ε \cdot {f}_{separation} \qquad ( 10 )$$

In Expression (10), f_{assign} is a value determined by the allocation result Xₛₑₗ. As long as the allocation time of each aircraft indicated by the allocation result Xₛₑₗ is within the range of times at which allocation is possible, f_{assign} has a larger value as the allocation time is earlier within the range of times at which allocation is possible. When the allocation time of each aircraft indicated by the allocation result Xₛₑₗ is a time at which allocation is impossible, f_{assign} is a smaller value such as −1000.

fₛₑₚₐᵣₐₜᵢₒₙ is a value determined by the allocation result Xₛₑₗ. When the allocation interval is greater than the minimum interval in which allocation is possible, fₛₑₚₐᵣₐₜᵢₒₙ is greater as the allocation interval is smaller. When the allocation interval is smaller than the minimum interval in which allocation is possible, fₛₑₚₐᵣₐₜᵢₒₙ is a small value such as −1000.

ε is a weighting factor.

The objective function value calculating unit 13 outputs the objective function value f to the function value adding unit 14.

The function value adding unit 14 acquires the penalty value p from the penalty value calculation processing unit 12 and acquires the objective function value f from the objective function value calculating unit 13.

The function value adding unit 14 performs weighted addition on the penalty function p and the objective function value f as represented by Expression (11) below.

$${p}^{′} = p + δ \cdot f \qquad ( 11 )$$

In Expression (11), δ is a weighting factor.

The function value adding unit 14 outputs the penalty value p′ to which the objective function value has been added to the second allocation result acquiring unit 15.

When being given the penalty value p′ from the penalty value calculating unit 11, the second allocation result acquiring unit 15 updates the second learning model 15a so as to decrease the penalty value p′.

When being given the schedule information S_{b} at the second time, the second allocation result acquiring unit 15 gives the schedule information S_{b} to the second learning model 15a, and acquires the second allocation result X_{b} from the second learning model 15a.

The second allocation result acquiring unit 15 outputs the second allocation result X_{b} to each of the change cost calculating unit 3, the reward value difference predicting unit 4, and the allocation result selecting unit 7.

In the third embodiment described above, the allocation result determination device illustrated in FIG. 15 includes the penalty value calculating unit 11 that calculates, when the allocation result selected by the allocation result selecting unit 7 has an allocation violation, a penalty value for the allocation violation. In addition, in the allocation result determination device illustrated in FIG. 15, the second allocation result acquiring unit 15 updates the second learning model 15a so as to decrease the penalty value calculated by the penalty value calculating unit 11. Therefore, the allocation result determination device illustrated in FIG. 15 can enhance the accuracy of selecting the allocation result as compared with the allocation result determination device illustrated in FIG. 1.

It is to be noted that, in the present disclosure, two or more of the above embodiments can be freely combined, or any component in the embodiments can be modified or omitted.

### INDUSTRIAL APPLICABILITY

The present disclosure is suitable for an allocation result determination device and an allocation result determination method.

### REFERENCE SIGNS LIST

1: first allocation result acquiring unit, 1a: first learning model, 2: second allocation result acquiring unit, 2a: second learning model, 3: change cost calculating unit, 4: reward value difference predicting unit, 5: allocation result difference detecting unit, 6: difference prediction processing unit, 6a: first prediction processing unit, 6b: second prediction processing unit, 6c: learning model, 6d: difference calculation processing unit, 7: allocation result selecting unit, 8: reward value difference calculating unit, 8a: first reward value calculating unit, 8b: second reward value calculating unit, 8c: difference calculation processing unit, 9: reward value difference predicting unit, 10: difference prediction processing unit, 10a: first prediction processing unit, 10b: second prediction processing unit, 10c: learning model, 10d: difference calculation processing unit, 11: penalty value calculating unit, 12: penalty value calculation processing unit, 13: objective function value calculating unit, 14: function value adding unit, 15: second allocation result acquiring unit, 15a: second learning model, 21: first allocation result acquiring circuit, 22: second allocation result acquiring circuit, 23: change cost calculating circuit, 24: reward value difference predicting circuit, 27: allocation result selecting circuit, 28: reward value difference calculating circuit, 29: reward value difference predicting circuit, 31: penalty value calculating circuit, 35: second allocation result acquiring circuit, 41: memory, 42: processor

1. An allocation result determination device comprising:
a processor; and
a memory storing a program, upon executed by the processor, to perform a process:
to acquire a first allocation result determined at a first time and a second allocation result determined at a second time later than the first time as an allocation result indicating an allocation order for a plurality of objects to be allocated, and calculate a change cost that is an amount of increase in cost when the allocation result is changed from the first allocation result to the second allocation result;
to give each of the first allocation result and the second allocation result to a learning model for reward value prediction, acquire a first reward value indicating a degree of quality of the first allocation result and a second reward value indicating a degree of quality of the second allocation result from the learning model, and predict a reward value difference between the first reward value and the second reward value by subtracting the first reward value from the second reward value;
to select the first allocation result or the second allocation result on a basis of a change cost calculated; and
to calculate the first reward value by giving the first allocation result to a reward function, calculate the second reward value by giving the second allocation result to the reward function, and calculate a reward value difference between the first reward value and the second reward value by subtracting the first reward value from the second reward value, wherein
the process
updates the learning model so as to decrease a difference between the reward value difference that has been predicted and the reward value difference calculated, and
the process
selects the second allocation result when the reward value difference is larger than 0 and the change cost is smaller than or equal to a cost threshold, and selects the first allocation result otherwise.

2. An allocation result determination device comprising:
a processor; and
a memory storing a program, upon executed by the processor, to perform a process:
to give schedule information of the plurality of objects to be allocated at the first time to a first learning model, acquire the first allocation result from the first learning model, and output the first allocation result;
to give schedule information of the plurality of objects to be allocated at the second time to a second learning model, acquire the second allocation result from the second learning model, and output the second allocation result;
to acquire a first allocation result determined at a first time and a second allocation result determined at a second time later than the first time as an allocation result indicating an allocation order for a plurality of objects to be allocated, and calculate a change cost that is an amount of increase in cost when the allocation result is changed from the first allocation result to the second allocation result;
to select the first allocation result or the second allocation result on a basis of a change cost calculated; and
to calculate, when an allocation result selected has an allocation violation, a penalty value for the allocation violation,
wherein
the process
gives the allocation result selected to an objective function, calculate a value of the objective function, and add an objective function value that is the value of the objective function to the penalty value, and
the process
updates the second learning model so as to decrease the penalty value to which the objective function value has been added.

3. An allocation result determination method of an allocation result determination device, the device comprising:
a processor; and
a memory storing a program, upon executed by the processor, to perform a process:
to acquire a first allocation result determined at a first time and a second allocation result determined at a second time later than the first time as an allocation result indicating an allocation order for a plurality of objects to be allocated, and calculate a change cost that is an amount of increase in cost when the allocation result is changed from the first allocation result to the second allocation result;
to give each of the first allocation result and the second allocation result to a learning model for reward value prediction, acquire a first reward value indicating a degree of quality of the first allocation result and a second reward value indicating a degree of quality of the second allocation result from the learning model, and predict a reward value difference between the first reward value and the second reward value by subtracting the first reward value from the second reward value;
to select the first allocation result or the second allocation result on a basis of a change cost calculated; and
to calculate the first reward value by giving the first allocation result to a reward function, calculate the second reward value by giving the second allocation result to the reward function, and calculate a reward value difference between the first reward value and the second reward value by subtracting the first reward value from the second reward value, the method comprising:
updating the learning model so as to decrease a difference between the reward value difference that has been predicted and the reward value difference calculated; and
selecting the second allocation result when the reward value difference is larger than 0 and the change cost is smaller than or equal to a cost threshold, and selecting the first allocation result otherwise.

4. An allocation result determination method of an allocation result determination device, the device comprising:
a processor; and
a memory storing a program, upon executed by the processor, to perform a process:
to give schedule information of the plurality of objects to be allocated at the first time to a first learning model, acquire the first allocation result from the first learning model, and output the first allocation result;
to give schedule information of the plurality of objects to be allocated at the second time to a second learning model, acquire the second allocation result from the second learning model, and output the second allocation result;
to acquire a first allocation result determined at a first time and a second allocation result determined at a second time later than the first time as an allocation result indicating an allocation order for a plurality of objects to be allocated, and calculate a change cost that is an amount of increase in cost when the allocation result is changed from the first allocation result to the second allocation result;
to select the first allocation result or the second allocation result on a basis of a change cost calculated; and
to calculate, when an allocation result selected has an allocation violation, a penalty value for the allocation violation, the method comprising
giving the allocation result selected to an objective function, calculating a value of the objective function, and adding an objective function value that is the value of the objective function to the penalty value, and
updating the second learning model so as to decrease the penalty value to which the objective function value has been added.
